(19) United States
(12) Patent Application Publication
(10) Pub. No.: US 2026/0326645 A1
(43) Pub. Date: Oct. 22, 2026

(54) STOWABLE VEHICLE TRAY TABLE

(71) Applicant: FCA US LLC, Auburn Hills, MI (US)

(72) Inventors: Joshua J. DeSouza, Auburn Hills, MI (US); Zachary A. Carter, Auburn Hills, MI (US); Jon P. Gaudreau, Auburn Hills, MI (US); Alexander B. McGowen, Auburn Hills, MI (US); Ryan C. Nagode, Auburn Hills, MI (US)

(21) Appl. No.: 19/181,502

(22) Filed: Apr. 17, 2025

(51) Int. Cl. B60N 3/00; B60R 7/04

(52) U.S. Cl. CPC B60N 3/002; B60R 7/04

(57) ABSTRACT

An interior for a vehicle may include a tray with a top surface, a bottom surface opposite the top surface, and an edge surface extends between the top surface and the bottom surface. A leg may be coupled to the tray at or near a first end and extends to a free end opposite to the first end, the leg may be movable relative to the tray from a retracted position in which the free end is positioned near the bottom surface to an extended position in which the free end is spaced from the bottom surface. The leg may be configured to be received in a socket of a storage cavity to support the tray.

### FIELD

The present disclosure relates to a tray table for an interior of a vehicle.

### BACKGROUND

Passengers of vehicles lack surfaces arranged to support items brought into the interior of the vehicle. For example, a passenger may be in the vehicle have need for a surface to set documents, mobile devices such as laptop computers, or a meal.

### SUMMARY

In at least some implementations, an interior for a vehicle may include a tray with a top surface, a bottom surface opposite the top surface, and an edge surface that extends between the top surface and the bottom surface. A leg may be coupled to the tray at or near a first end, the leg has a free end opposite to the first end, the leg is movable relative to the tray from a retracted position in which the free end is positioned near the bottom surface to an extended position in which the free end is spaced from the bottom surface. A storage cavity that has a bottom wall, one or more side walls may extend from the bottom wall to an upper end. A socket may be formed at least in part in one or more of the bottom wall or side walls and may be configured to receive at least part of the leg including the free end of the leg when the leg is in the extended position, wherein the socket has a socket bottom surface that is parallel to the bottom wall, a socket first side surface, a socket second side surface spaced from the socket first side surface by a distance sufficient to receive part of the leg between the socket first side surface and the socket second side surface.

In at least some implementations, when the leg has a leg first surface and a leg second surface, and the leg is adapted to be received in the socket with the leg first surface adjacent to one of the socket first side surface or the socket second side surface, the leg second surface is adjacent to the other of the socket first side surface or the socket second side surface, and the free end of the leg is adjacent to the bottom surface of the socket.

In at least some implementations, the socket first side surface and the socket second side surface extend beyond the side wall(s) of the storage cavity.

In at least some implementations, the bottom surface of the socket is positioned beyond the bottom wall of the storage cavity.

In at least some implementations, the leg is configured to be received in the socket in a first orientation where the leg first surface abuts the socket first side surface, and the leg is configured to be received in the socket in a second orientation where the leg first surface abuts the socket second side surface.

In at least some implementations, the tray has a recess in the bottom surface defined by an end wall and side surfaces extending from the bottom surface to the end wall.

In at least some implementations, the leg is pivotably movable between the retracted position where a lower surface of the leg is parallel with the bottom surface and the extended position where a leg first surface is oriented 90 degrees plus or minus 5 degrees from the bottom surface.

In at least some implementations, when in the retracted position, a leg second surface is parallel with the bottom surface.

In at least some implementations, interior further comprises a console, wherein the console has a storage compartment and a cover, the cover has a cover top surface facing the interior of the vehicle and a cover bottom surface opposite to the cover top surface and having a slot configured to receive the tray.

In at least some implementations, the cover is movable between a closed position where the cover bottom surface covers at least part of the storage compartment and an open position exposing the storage compartment, when the cover is moved from the closed position, the slot is accessible so that the tray is capable of being inserted into the slot or removed from the slot.

In at least some implementations, an interior for a vehicle may include a tray with a top surface, a bottom surface opposite the top surface, and an edge surface extends between the top surface and the bottom surface. A console may have a storage compartment and a cover, the cover has a cover top surface facing the interior of the vehicle and a cover bottom surface opposite to the cover top surface and having a slot configured to receive the tray, the cover is movable between a closed position where the cover bottom surface covers at least part of the storage compartment and an open position exposing the storage compartment, when the cover is moved from the closed position, the slot is accessible so that the tray is capable of being inserted into the slot or removed from the slot.

In at least some implementations, the interior further comprises a storage cavity within the interior, wherein the storage cavity has a bottom wall, one or more side walls extending from the bottom wall to an upper end, and a socket formed at least in part in one or more of the bottom wall or side walls.

In at least some implementations, a leg is coupled to the tray at or near a first end, the leg has a free end opposite to the first end, the leg is movable relative to the tray from a retracted position in which the free end is positioned near the bottom surface to an extended position in which the free end is spaced from the bottom surface.

In at least some implementations, the socket has a socket bottom surface that is parallel to the bottom wall, a socket first side surface, a socket second side surface spaced from the socket first side surface by a distance sufficient to receive part of the leg between the socket first side surface and the socket second side surface and is configured to receive at least part of the leg including the free end of the leg when the leg is in the extended position.

In at least some implementations, the leg has a leg first surface and a leg second surface, and the leg is adapted to be received in the socket with the leg first surface adjacent to one of the socket first side surface or the socket second side surface, the leg second surface is adjacent to the other of the socket first side surface or the socket second side surface, and the free end of the leg is adjacent to the bottom surface of the socket.

In at least some implementations, the socket first side surface and the socket second side surface extend beyond the side wall(s) of the storage cavity.

In at least some implementations, the bottom surface of the socket is positioned beyond the bottom wall of the storage cavity.

In at least some implementations, the leg is configured to be received in the socket in a first orientation where the leg first surface abuts the socket first side surface, and the leg is configured to be received in the socket in a second orientation where the leg first surface abuts the socket second side surface.

In at least some implementations, the tray has a recess in the bottom surface defined by an end wall and side surfaces extending from the bottom surface to the end wall and the leg is pivotably movable between the retracted position where a lower surface of the leg is parallel with the bottom surface and the extended position where a leg first surface is oriented 90 degrees plus or minus 5 degrees from the bottom surface.

In at least some implementations, when in the retracted position, a leg second surface is parallel with the bottom surface.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of part of an interior of a vehicle;

FIG. 2 is a top view of a storage cavity within the interior;

FIG. 3 is a cross-sectional view of the storage cavity of FIG. 2;

FIG. 4 is a diagrammatic perspective view of a tray the storage cavity of FIGS. 2-3;

FIG. 5 is a bottom view of the tray with a leg in a retracted position;

FIG. 6 is a side view of the tray of FIG. 5;

FIG. 7 is a bottom view of the tray of FIGS. 5-6, with the leg in an extended position;

FIG. 8 is a side view of the tray of FIG. 7;

FIG. 9 is a bottom view of a cover of a console with a slot for the tray of FIGS. 5-6;

FIG. 10 is a front view of the cover of FIG. 9.

### DETAILED DESCRIPTION

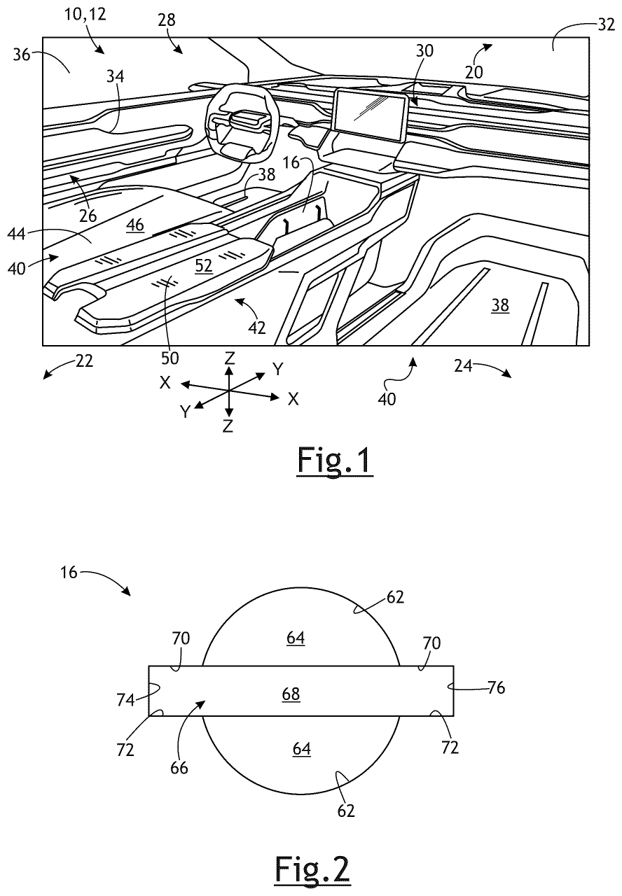

Referring in more detail to the drawings, FIG. 1 shows an interior 10 of a vehicle 12 that includes a tray 14 that may be installed in one or more storage cavities 16 to provide a work surface for a user of the vehicle 12, and that may be stowed when not in use. The vehicle 12 has a body defining an exterior and the interior 10 of the vehicle 12. Portions of the vehicle 12 and the interior 10 can be described relative to a fore-aft direction that extends from a front side 20 to a rear side 22 of the vehicle 12 (as shown by arrow XX) and a cross-car direction that extends from a right side 24 to a left side 26 of the vehicle 12 (as shown by arrow YY).

The vehicle interior 10 includes a passenger compartment 28 that extends in the fore-aft direction XX between a dashboard 30 and a windshield 32 and a rear window or trunk, and in the cross-car direction YY, between opposite right and left sides 24, 26 of the vehicle 12 which may include one or more doors 34 and associated windows 36. The passenger compartment 28 is further defined in a vertical direction, perpendicular to both the fore-aft direction and the cross-car direction by a floor 38 and a roof of the vehicle 12 (as shown by arrow ZZ in FIG. 1). Seats 40, storage cavities 16, and consoles 42 may be also included in the passenger compartment 28.

In an example shown in FIG. 1, the passenger compartment 28 has two seats 40 positioned aft of the dashboard 30 and spaced apart in the cross-car direction. The seats 40 may have a seat bottom 44 mounted to the floor 38 with a top surface 46 of the seat bottom 44 extending a length in the fore-aft direction and a width in the cross-car direction. The seat bottoms 44 are generally parallel to the floor 38, although in some implementations the exact angle may be adjusted by the user, and are configured to support a user or passenger of the vehicle 12 in a vertical direction. A seatback is mounted adjacent to each seat bottom 44 and extends in the vertical direction upwardly beyond the top surface 46 of the seat bottom 44 towards the roof. A front surface of the seat back faces forward or in the fore-aft direction and a back surface of the seat back faces rearward or in the fore-aft direction. The front surface of the seat back is configured to support a user or passenger of the vehicle in conjunction with the seat bottom 44.

A console 42 may be positioned in between two seats 40, may extend from the floor 38 and may include a storage compartment 48 and a cover 50. The storage compartment 48 is a cavity in the console 42 with a closed bottom to provide storage for items a vehicle occupant may bring or leave in the vehicle 12. A top of the console 42 is open to provide access to the storage compartment 48.

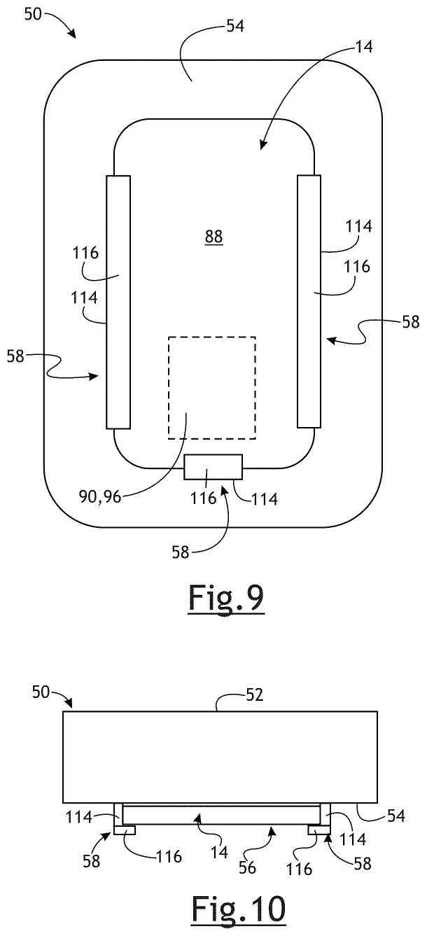

The cover 50 is movably (e.g. pivotably or slidably) mounted to the console 42 above the top to selectively cover the storage compartment 48 or to provide a resting surface for an arm of an occupant of the vehicle 12. The cover 50 is movable between an open position, where the cover 50 exposes the storage compartment 48 and a closed position where the cover 50 encloses or covers the storage compartment 48. The cover 50 has a cover top surface 52 and a cover bottom surface 54, the cover bottom surface 54 is configured to cover the open top of the storage compartment 48 and the cover top surface 52 is arranged opposite to the cover bottom surface 54. A slot 56 may be formed in or attached to the cover bottom surface 54 of the cover 50, possibly defined by one or more brackets 58, as shown in FIG. 9, and may be configured to receive a tray 14 as set forth in more detail later.

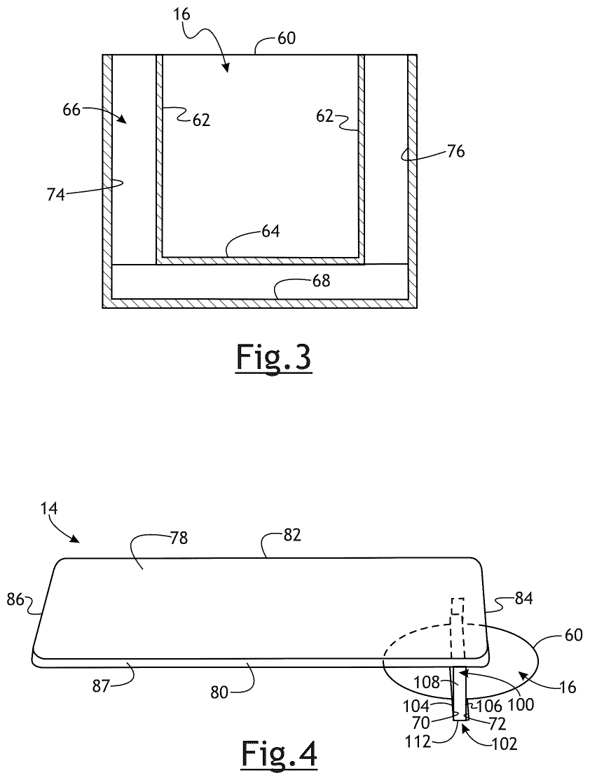

One or more than one storage cavity 16 may be located on or near the console 42 or elsewhere in the interior 10 of the vehicle 12. For simplicity, a single storage cavity will be described with the understanding that multiple storage cavities may be provided in the vehicle 12. The storage cavity 16 may be a cup holder or other storage feature within the interior 10 of the vehicle 12. As shown in FIGS. 2-3, the storage cavity 16 has an open upper end 60, one or more side walls 62 that extend vertically down from the upper end 60 and to a bottom wall 64 that defines the bottom of the storage cavity 16. In the implementation shown in FIGS. 2-3, the upper end 60 and sidewall 62 are circular, to accommodate cups having complementary rounded exterior surface, or other objects, however, depending on the application the storage cavity 16 may have other shapes or sizes.

A socket 66 is formed at least in part in one or more of the side walls 62 and/or the bottom wall 64 of the storage cavity 16. The socket 66 is open to the storage cavity 16 and may be defined in part by the storage cavity 16. In at least some implementations, the socket 66 has one dimension (e.g. a depth or width) that is greater than a corresponding dimension of the storage cavity 16. In the example shown in FIGS. 2 and 3, the socket 66 is both deeper and wider than the storage cavity 16. In this example, the socket 66 bisects the storage cavity 16 and extends outwardly from diametrically opposed locations of the storage cavity side wall(s) 62. The socket 66 includes a bottom surface 68, a first side surface 70, a second side surface 72, a first end surface 74, and a second end surface 76. The socket bottom surface 68 may be parallel to the bottom wall 64 of the storage cavity 16, and may be at the same height or offset below the bottom wall 64 in the vertical direction as in the example shown. The socket first side surface 70 is opposite to the socket second side surface 72, where the socket side surfaces 70, 72 collectively extend vertically upward from the socket bottom surface 68. As shown in FIGS. 2-3, the socket end surfaces 74, 76 extend vertically upward from the socket bottom surface 68 and between the socket side surfaces 70, 72, however, other configurations and shapes of the socket 66 are possible depending on the desired application.

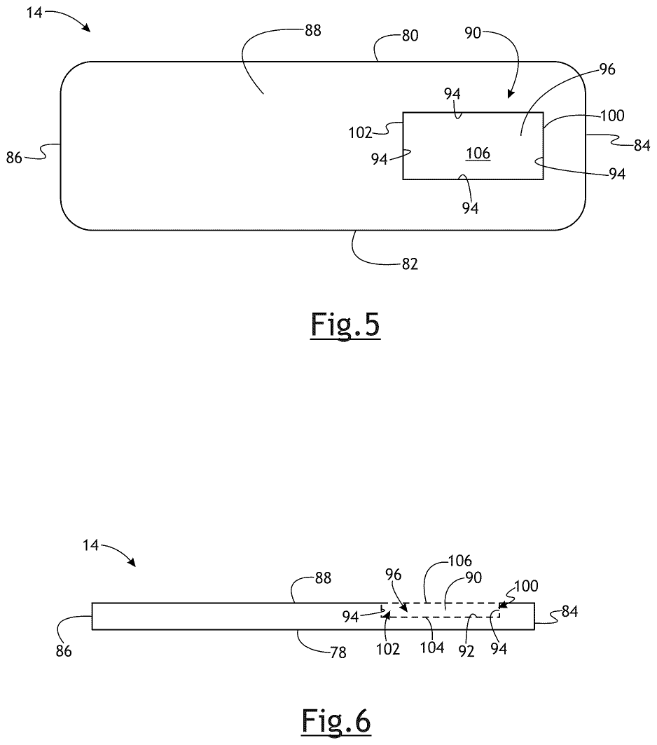

As shown in FIGS. 4-8, a tray 14 may be provided for use in the vehicle interior 10. The tray 14 has a top surface 78 that may be flat and have a width between opposite sides 80, 82 and a length between first and second ends 84, 86. The sides 80, 82 and ends 84, 86 define an edge surface 87 of the tray 14 that extends from the top surface 78 to a bottom surface 88 of the tray 14 that is arranged opposite to the top surface 78 and may be parallel to and coextensive with the top surface 78. The edge surface 87 defines a thickness of the tray 14. Referring specifically to FIGS. 5-6, the tray 14 may include a recess 90 that extends inwardly in the bottom surface 88 part of the way toward the top surface 78. The recess 90 may include an end wall 92 that may be parallel to the bottom surface 88 and recess side surfaces 94 that extend from the recess end wall 92 and define the boundaries of the recess 90 within the tray 14.

As shown by FIGS. 3 and 7-9, a leg 96 is coupled to one or both of the bottom surface 88 and/or the edge surface 87 of the tray 14. The leg 96 may be hinged or otherwise pivotably connected to the tray 14 by a mount 98 (FIG. 8) at a first end 100 and extend from the first end 100 to a free, second end 102. The leg 96 has a first surface 104, second surface 106 opposite to the first surface 104, first and second sides 108, 110 extending between the first surface 102 and the second surface 104, and a lower surface 112 at the second end 102 of the leg 96.

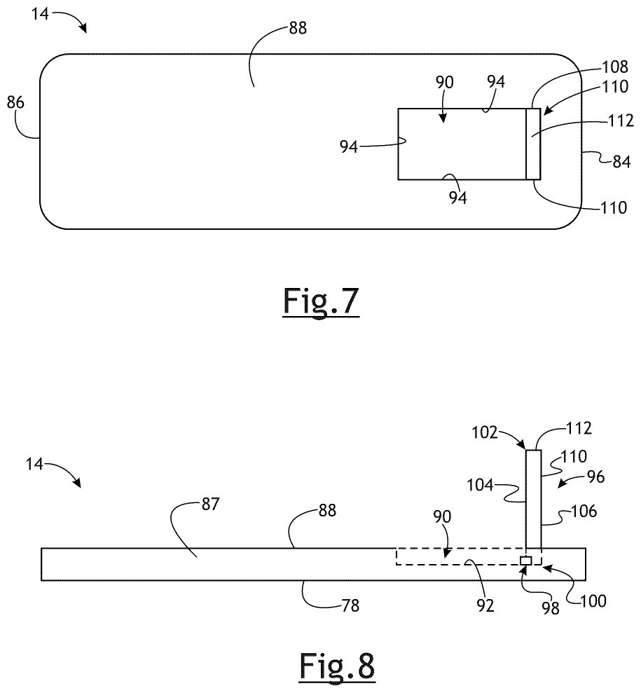

As shown by FIGS. 5-8, the leg 96 is movable relative to the tray 14 between a retracted position (shown in FIGS. 5 and 6) and an extended position (shown in FIGS. 7 and 8). In the retracted position, the leg 96 may be received at least partly in the recess 90 with the first surface 104 of the leg 96 flat against the recess end wall 92, and between the side surfaces 94 of the recess 90. In the extended position, the leg 96 is rotated about the mount 98 so that the second or free end 102 of the leg 96 is spaced from the bottom surface 88, and the leg 96 may be perpendicular or nearly perpendicular to the bottom surface 88 of the tray 14. In this context, nearly perpendicular means within 5 degrees of perpendicular. In at least some implementations, a centerline through the first and second ends 100, 102 of the leg 96 may be perpendicular to the bottom surface 88 of the tray 14.

As shown in FIG. 4, when the leg 96 is in the extended position, the tray 14 may be installed into the socket 66 of the storage cavity 16. Thus, the socket side surfaces 70, 72 are spaced apart a distance sufficient to receive at least part of the leg 96 between them. In a standard orientation, part of the leg 96 including the second end 102 of the leg 96 is received in the socket 66, and may be supported in the socket 66 by engagement of the second end 86 of the leg 96 with the bottom surface 68 of the socket 66. To limit movement of the tray 14 relative to the socket 66, the socket surfaces 68, 70, 72, 74, 76 may be arranged to closely to receive and may abut adjacent surfaces 104, 106, 112 of the leg 96 for desired stability of the tray 14. In the example shown, at least part of the first surface 104, the second surface 106, and the side surfaces 108, 110 of the leg 96 are enclosed between surfaces of the socket 66 including the bottom surface 68, the first side surface 70, the second side surface 72, the first end surface 74, and the second end surface 76. For example, as shown in FIG. 4, the leg first surface 104 is adjacent to and may abut the socket first side surface 70, the leg second surface 106 is adjacent to and may abut the socket second side surface 72, the leg first side surface 108 is adjacent to and may abut the socket first end surface 74, the leg second side surface 106 is adjacent to and may abut the socket second end surface 76, and the lower surface 112 of the leg 96 is adjacent to and may abut the bottom surface 68 of the socket 66.

When the leg 96 is received in the socket 66, the tray 14 is positioned above and extends outwardly from the storage cavity 16. Depending on the orientation of the storage cavity 16 and socket 66 relative to the interior 10 of the vehicle 12, the tray 14 may be configured to extend at least partially over one of the seat bottoms 44, so that the tray 14 may support items brought into the interior 10 of the vehicle 12 by an occupant of the vehicle 12. If the configuration of the interior 10 permits, the orientation of the tray 14 and leg 96 with respect to the storage cavity 16 and the socket 66 may be reversed. In the second or reverse orientation, the leg first surface 104 abuts the socket second side surface 72, the leg second surface 106 abuts the socket first side surface 70, the leg second side surface 110 abuts the socket first end surface 74, and the leg first side surface 108 abuts the socket second end surface 76. In the reverse orientation, the tray 14 extends in a second direction that is 180 degrees rotated from the standard or first orientation. This may position the tray 14 relative to another seat 40 within the interior 10.

The height of the tray 14 relative to other components of the vehicle interior 10 may be configured by adjusting the length of the leg 96 from the first end 100 to the second end 102 to raise or lower the tray 14 relative to the storage cavity 16. Furthermore, the position of the storage cavity 16 and socket 66 may be changed relative to the interior 10 of the vehicle 12 to raise or lower the tray 14 or to adjust the direction and position the tray 14 extends within the interior 10 or additional storage cavities 16 and sockets 66 may be added within the interior 10. In some vehicles, multiple cupholders and other storage cavities 16 are provided, and a socket 66 may be provided in any or all such storage cavities 16 to permit mounting a tray 14 in different locations within the vehicle 10. Further, multiple trays 14 may be provided and used at the same time by mounting them in different sockets 66 in the passenger compartment 28.

For convenience, the tray 14 may be stowed within the slot 56 of the cover 50 of the console 42, when the tray 14 is not in use. In the example shown, brackets 58 are coupled to and extend from the bottom surface 54 of the cover 50. Side walls 114 of the brackets 58 are spaced apart a distance equal to or greater than the width of the tray 14 and have a length equal to or greater than the thickness of the tray 14, and end walls 116 of the bracket 58 extend inwardly to free ends 118 that are spaced apart less than the width of the tray 14, to overlap part of the tray 14 when stored, as shown in FIGS. 9 and 10. The slot 56 may be defined by other features or components, such as but not limited to, as U-shaped piece of material that fully overlaps either the top or bottom of the tray 14, or a sheet of material, like a fabric that is connected along opposite edges to the cover 50 to define a slot or pouch in which the tray 14 may be received between the bottom surface 54 of the cover 50 and the sheet of material.

To store the tray 14 in the slot 56, the leg 96 of the tray 14 is placed in the retracted position so that the leg 96 is folded into the recess 90 or otherwise folded against the bottom surface 88 of the tray 14. The cover 50 of the console 42 is moved to expose the bottom surface 54 and the slot 56 of the cover 50. The tray 14 may then be inserted into the slot 56 of the cover 50 and the cover 50 may be returned to the closed position. The tray 14 may remain in the slot 56 of the cover 50, within the storage compartment 48 until needed. To remove the tray 14 from the slot 56 of the cover 50, the cover 50 is moved from the closed position and the tray 14 may be withdrawn from the slot 56.

The storage cavity 16 and tray 14 may be simply designed and enable easy use of a sturdy tray table within the vehicle 12. Further, the console cover 50 can include a storage slot 56 for the tray 14 so that the tray 14 can be maintained in the vehicle 12 and out of the way of occupants of the vehicle 12 when not in use. Finally, multiple sockets 66 enable use of one or more trays 14 in different areas of the vehicle 12, for the convenience of occupants in different areas of the passenger compartment 28.

What is claimed is:

1. An interior for a vehicle comprising:
a tray with a top surface, a bottom surface opposite the top surface, and an edge surface that extends between the top surface and the bottom surface;
a leg coupled to the tray at or near a first end, the leg has a free end opposite to the first end, the leg is movable relative to the tray from a retracted position in which the free end is positioned near the bottom surface to an extended position in which the free end is spaced from the bottom surface; and
a storage cavity that has a bottom wall, one or more side walls extending from the bottom wall to an upper end, and a socket formed at least in part in one or more of the bottom wall or side walls and configured to receive at least part of the leg including the free end of the leg when the leg is in the extended position, wherein the socket has a socket bottom surface that is parallel to the bottom wall, a socket first side surface, a socket second side surface spaced from the socket first side surface by a distance sufficient to receive part of the leg between the socket first side surface and the socket second side surface.

2. The interior of claim 1, wherein when the leg has a leg first surface and a leg second surface, and the leg is adapted to be received in the socket with the leg first surface adjacent to one of the socket first side surface or the socket second side surface, the leg second surface is adjacent to the other of the socket first side surface or the socket second side surface, and the free end of the leg is adjacent to the bottom surface of the socket.

3. The interior of claim 2, wherein the socket first side surface and the socket second side surface extend beyond the one or more side walls of the storage cavity.

4. The interior of claim 2, wherein the bottom surface of the socket is positioned beyond the bottom wall of the storage cavity.

5. The interior of claim 2, wherein the leg is configured to be received in the socket in a first orientation where the leg first surface abuts the socket first side surface, and the leg is configured to be received in the socket in a second orientation where the leg first surface abuts the socket second side surface.

6. The interior of claim 1, wherein the tray has a recess in the bottom surface defined by an end wall and side surfaces extending from the bottom surface to the end wall.

7. The interior of claim 6, wherein the leg is pivotably movable between the retracted position where a lower surface of the leg is parallel with the bottom surface and the extended position where a leg first surface is oriented 90 degrees plus or minus 5 degrees from the bottom surface.

8. The interior of claim 7, wherein in the retracted position, a leg second surface is parallel with the bottom surface.

9. The interior of claim 1, further comprising a console, wherein the console has a storage compartment and a cover, the cover has a cover top surface facing the interior of the vehicle and a cover bottom surface opposite to the cover top surface and having a slot configured to receive the tray.

10. The interior of claim 9, wherein the cover is movable between a closed position where the cover bottom surface covers at least part of the storage compartment and an open position exposing the storage compartment, when the cover is moved from the closed position, the slot is accessible so that the tray is capable of being inserted into the slot or removed from the slot.

11. An interior for a vehicle comprising:
a tray with a top surface, a bottom surface opposite the top surface, and an edge surface extends between the top surface and the bottom surface; and
a console, wherein the console has a storage compartment and a cover, the cover has a cover top surface facing the interior of the vehicle and a cover bottom surface opposite to the cover top surface and having a slot configured to receive the tray, the cover is movable between a closed position where the cover bottom surface covers at least part of the storage compartment and an open position exposing the storage compartment, when the cover is moved from the closed position, the slot is accessible so that the tray is capable of being inserted into the slot or removed from the slot.

12. The interior of claim 11, further comprising a storage cavity within the interior, wherein the storage cavity has a bottom wall, one or more side walls extending from the bottom wall to an upper end, and a socket formed at least in part in one or more of the bottom wall or side walls.

13. The interior of claim 12, further comprising a leg coupled to the tray at or near a first end of the leg, the leg has a free end opposite to the first end, the leg is movable relative to the tray from a retracted position in which the free end is positioned near the bottom surface to an extended position in which the free end is spaced from the bottom surface.

14. The interior of claim 13, wherein the socket has a socket bottom surface that is parallel to the bottom wall, a socket first side surface, a socket second side surface spaced from the socket first side surface by a distance sufficient to receive part of the leg between the socket first side surface and the socket second side surface and is configured to receive at least part of the leg including the free end of the leg when the leg is in the extended position.

15. The interior of claim 14, wherein when the leg has a leg first surface and a leg second surface, and the leg is adapted to be received in the socket with the leg first surface adjacent to one of the socket first side surface or the socket second side surface, the leg second surface is adjacent to the other of the socket first side surface or the socket second side surface, and the free end of the leg is adjacent to the bottom surface of the socket.

16. The interior of claim 15, wherein the socket first side surface and the socket second side surface extend beyond the side wall(s) of the storage cavity.

17. The interior of claim 15, wherein the bottom surface of the socket is positioned beyond the bottom wall of the storage cavity.

18. The interior of claim 15, wherein the leg is configured to be received in the socket in a first orientation where the leg first surface abuts the socket first side surface, and the leg is configured to be received in the socket in a second orientation where the leg first surface abuts the socket second side surface.

19. The interior of claim 13, wherein the tray has a recess in the bottom surface
defined by an end wall and side surfaces extending from the bottom surface to the end wall and the leg is pivotably movable between the retracted position where a lower surface of the leg is parallel with the bottom surface and the extended position where a leg first surface is oriented 90 degrees plus or minus 5 degrees from the bottom surface.

20. The interior of claim 19, wherein in the retracted position, a leg second surface is parallel with the bottom surface.
